(19) United States
(12) Patent Application Publication
(10) Pub. No.: US 2011/0122107 A1
(43) Pub. Date: May 26, 2011

(54) Portable electronic display apparatus, control method of portable electronic display apparatus and control program of portable electronic display apparatus

(75) Inventor: Yu Onkura, Shizuoka (JP)

(73) Assignee: NEC Access Technica, Ltd., Kakegawa-shi (JP)

(21) Appl. No.: 12/923,430

(22) Filed: Sep. 21, 2010

(30) Foreign Application Priority Data
Nov. 24, 2009 (JP) 2009-266017

(51) Int. Cl. G09G 5/00

(52) U.S. Cl. 345/207; 345/1.3

(57) ABSTRACT

A portable electronic display apparatus includes at least two screen units whose intersecting angle is changeable; an inclination detecting device, which are mounted on each of the screen units, for detecting inclination with the ground; a watched screen detecting device for detecting a screen unit which user watches through comparing the inclination values of the screen units each other; and a screen display controlling device for carrying out a page turning in the case that the watched screen detecting device detects that a screen unit which user watches is switched over and judges that a predetermined page turning executing condition is satisfied.

This application is based upon and claims the benefit of priority from Japanese Patent Application No. 2009-266017, filed on Nov. 24, 2009, the disclosure of which is incorporated herein in its entirety by reference.

### TECHNICAL FIELD

The present invention relates to a portable electronic display apparatus, and a control method of the portable electronic display apparatus and a program of the portable electronic display apparatus.

### BACKGROUND ART

In recent years, it becomes prevailing that person enjoys reading through displaying sentence data, which are stored in an electronic medium, on a portable electronic display apparatus instead of reading a book, which is made of a paper medium, as a reading style. For example, a name of “electronic book” is typical as the portable electronic display apparatus based on the method. FIG. 11 and FIG. 12 show examples of the electronic display apparatus respectively which are used as a general electronic book. Specifically, FIG. 11 shows an one screen type electronic book and FIG. 12 shows a two spread screens type electronic book in an unfolded state. According to the electronic book, a page which includes an image to be displayed on an image displaying unit 102 mounted on a body of electronic book 101 is turned by handling an operation button 103, similarly to a case of reading a conventional book. The electronic book is expected because it can carry a large amount of sentence data compactly, because of its relatively low cost, and because it can save paper resource, all of which the paper book lacks.

However, according to the electronic book mentioned above, it is necessary to carry out handling the button or the like, which is peculiar to the electronic book, in order to turn a page (to switch over display screen). Since the above-mentioned handling is different substantially from turning a page when the conventional book is read, and the handling is complex in general, user feels uncomfortable. As a result, it is difficult to read the electronic book for a long time. For this reason, an art, by which user of the portable electronic display apparatus can turn a page with natural feeling as far as possible, has been studied.

For example, as an art to turn a page through inclining the electronic book, Japanese Patent Application Laid-Open No. 2008-116791 (hereinafter, referred to as “patent document 1”) discloses an art that user turns a page through inclining a portable electronic displaying apparatus which includes a dual view liquid crystal display screen and an inclination sensor. Here, the dual view liquid crystal display screen means a display apparatus by which it is possible to watch different images from two different directions respectively. According to the method for turning a page, in the case that user reads a sentence which is displayed on a screen from the left to the right, the display screen of the portable electronic apparatus displays the first page and the second page so that user may read the first page and the second page from the left side and from the right side respectively. Then, user reads the first page from the left side of the display screen through inclining the portable electronic apparatus to the right and next, reads the second page from the right side of the screen through inclining the portable electronic apparatus to the left. When user inclines the portable electronic apparatus to the right again, display on the screen is switched over so that user may read similarly the third page and the fourth page from the left side and from the right side respectively. This operation is continued hereinafter to read the latter part of the electronic book.

### SUMMARY

An exemplary object of the present invention is to provide a portable electronic display apparatus, a control method of the portable electronic display apparatus and a control program of the mobile electronic display apparatus, by which user can turn a page with no consciousness of operation, that is, with a natural feeling, even if the portable electronic display apparatus includes a plurality of screens.

A portable electronic display apparatus according to an exemplary aspect of the invention includes at least two screen units whose intersecting angle is changeable; an inclination detecting device, which are mounted on each of the screen units, for detecting inclination with the ground; a watched screen detecting device for detecting a screen unit which user watches through comparing the inclination values of the screen units each other; and a screen display controlling device for carrying out a page turning in the case that the watched screen detecting means detects that a screen unit which user watches is switched over and judges that a predetermined page turning executing condition is satisfied.

A control method of a portable electronic display apparatus including at least two screen units whose intersecting angle is changeable and each of which includes an inclination detecting device, the method according to an exemplary aspect of the invention includes the steps of detecting a screen unit which user watches through comparing the inclination values of the screen units each other; and turning page in the case that it is detected that a screen unit which user watches is switched over and it is judged that a predetermined page turning executing condition is satisfied.

A control program of a portable electronic display apparatus including at least two screen units whose intersecting angle is changeable and each of which includes an inclination detecting device, according to an exemplary aspect of the invention, includes the steps of detecting a screen unit which user watches through comparing the inclination values of the screen units each other; and turning page in the case that it is detected that a screen unit which user watches is switched over and it is judged that a predetermined page turning executing condition is satisfied.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration according to an exemplary embodiment of the present invention;

FIGS. 2A to 2D are schematic diagrams showing electronic books respectively according to a second exemplary embodiment of the present invention;

FIG. 3 is a flow chart showing an operation according to the second exemplary embodiment of the present invention;

FIG. 4 is a flow chart showing a control operation for turning a page according to the second exemplary embodiment of the present invention;

FIG. 5 is a schematic diagram showing an electronic book according to a third exemplary embodiment of the present invention;

FIG. 6 is a flow chart showing an operation according to the third exemplary embodiment of the present invention;

FIG. 7 is a flow chart showing a page turning control B according to the third exemplary embodiment of the present invention;

FIGS. 8A to 8C are schematic diagrams showing changing states of a display on a screen according to the third exemplary embodiment of the present invention;

FIG. 9 is a flow chart showing an operation according to a fourth exemplary embodiment of the present invention;

FIG. 10 is a schematic diagram showing an electronic book according to the fourth exemplary embodiment of the present invention;

FIG. 11 is a schematic diagram showing a general one screen type electronic book; and

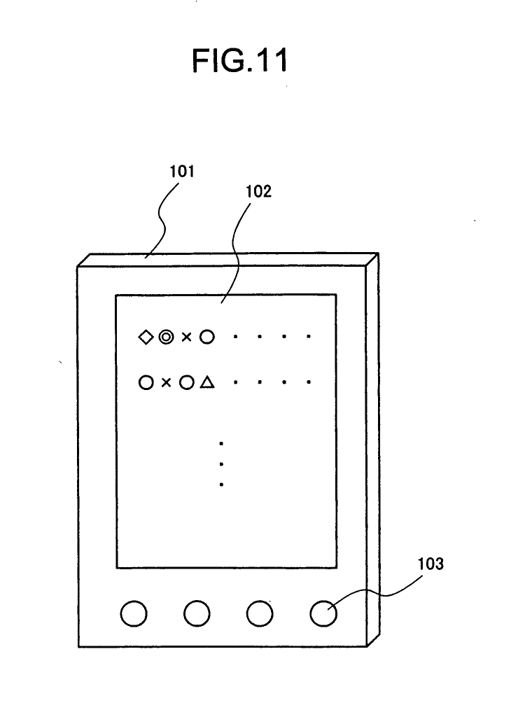

FIG. 12 is a schematic diagram showing a general two spread screens type electronic book.

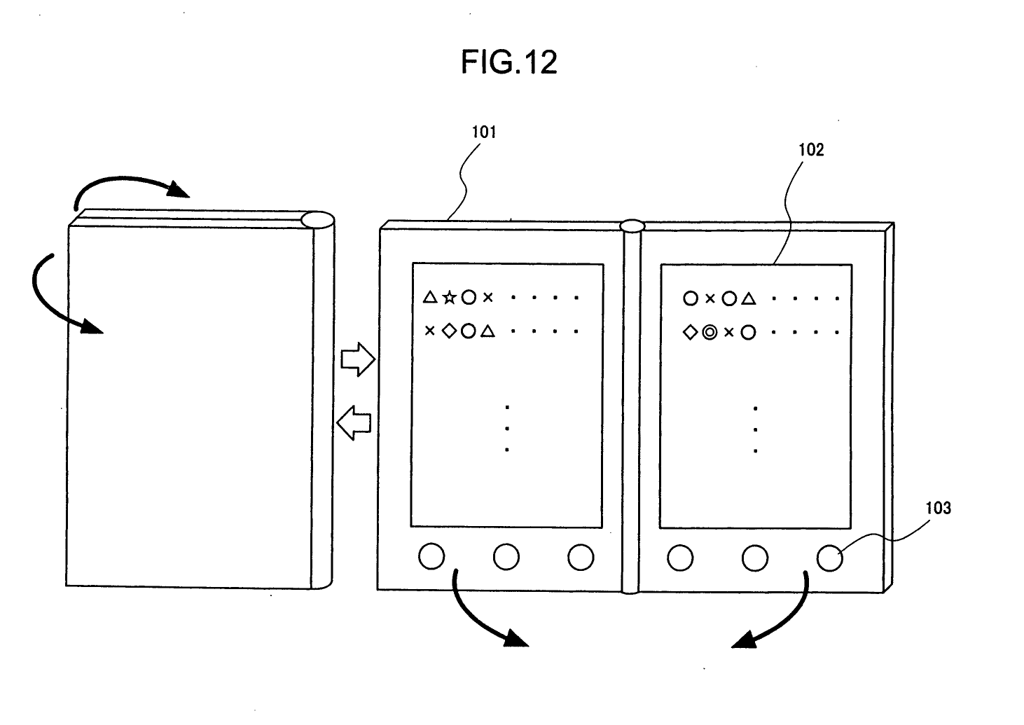

### EXEMPLARY EMBODIMENT

Next, a first exemplary embodiment of the present invention will be described with reference to a drawing.

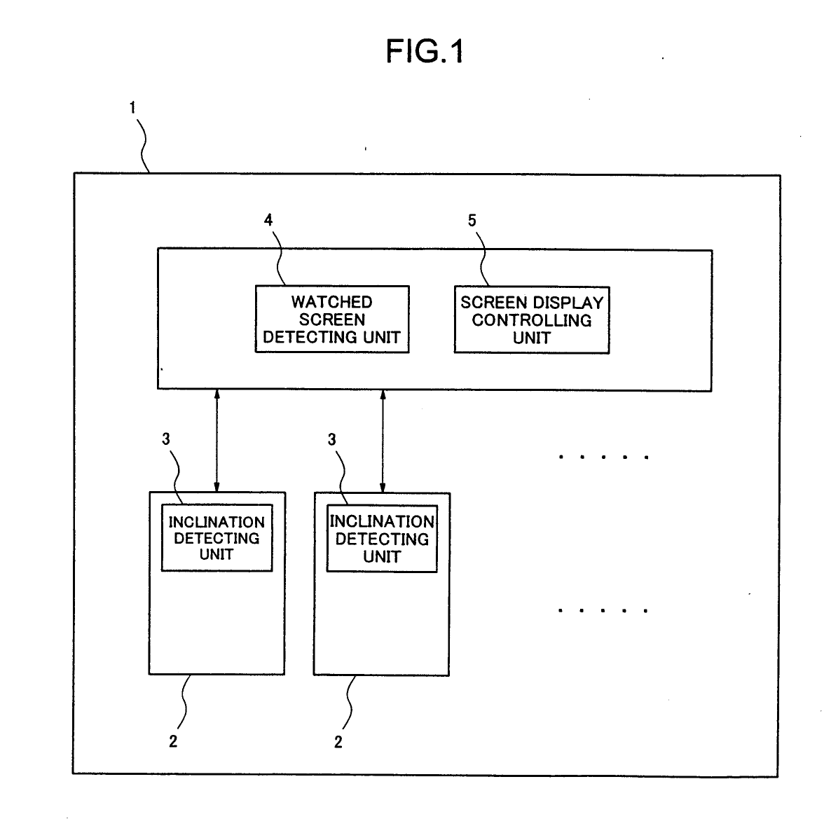

FIG. 1 is a block diagram showing a configuration of a portable electronic display apparatus as an electronic book according to the exemplary embodiment of the present invention. An electronic book 1 includes at least two screen units 2 and an intersecting angle of two screen units 2 is changeable. Moreover, each of screen units 2 includes an inclination detecting unit 3 which detects inclination of the screen unit 2 with the ground. A watched screen detecting unit 4 specifies a screen unit which user watches through comparing values of inclination angles of screen units 2 each other. A screen display controlling unit 5 detects that a screen which user watches is switched over from one screen which is specified by the watched screen detecting unit 4 to be the screen which user has watched to the other screen unit. Then, the screen display controlling unit 5 judges whether switch of the screen unit satisfies a page turning executing condition which is predetermined in advance. In the case of judging that the page turning executing condition is satisfied, the screen display control unit 5 carries out the page turning operation.

According to the present embodiment, switch of the screen which user watches is detected through detecting change of the inclination angle of each screen and the page turning operation is carried out automatically when a page to be turned is detected. As a result, it is possible that user turns a page with no particular consciousness of the operation for switching the display screen and with a natural feeling, in the portable electronic display apparatus which includes a plurality of screens.

Next, a second exemplary embodiment will be described with reference to drawings. An electronic book according to the present exemplary embodiment is two spread screens type, and a basic configuration of the electronic book is similar to one shown in FIG. 1. It is preferable that the electronic book includes furthermore a mechanism to obtain data from air or an external storage medium, a memory unit to store the obtained data and a data processing unit to process data.

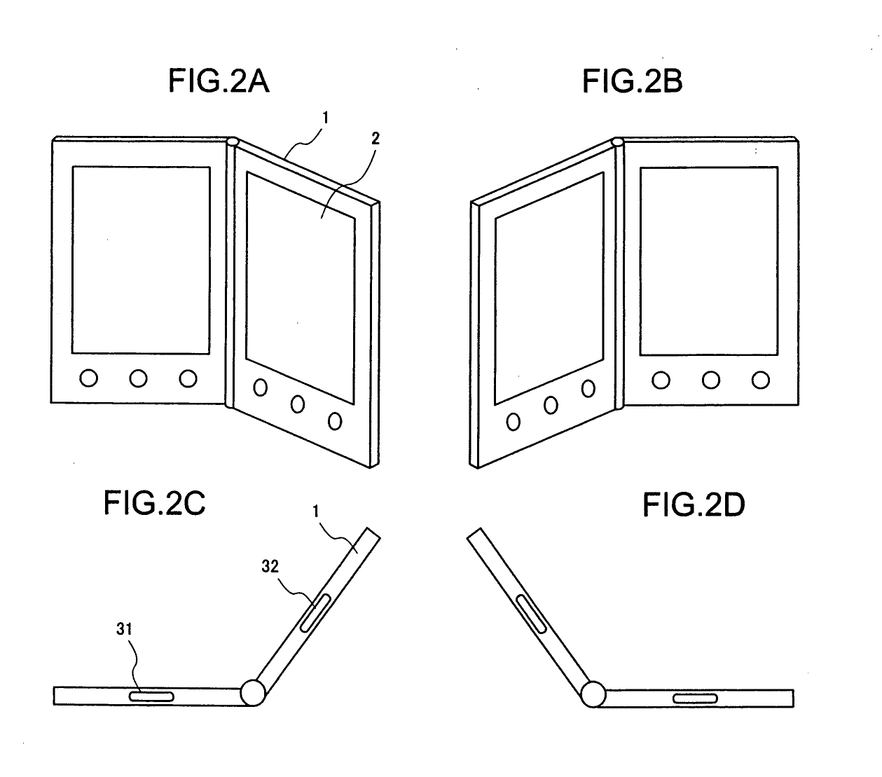

FIGS. 2A to 2D are schematic diagrams showing the electronic book of two spread screens type respectively according to the second exemplary embodiment. In the following description, the same code as one shown in FIG. 1 is attached to the same component as one shown in FIG. 1. A usual liquid crystal display apparatus is applied to the screen unit 2 of the electronic book 1. Angular velocity sensors 31 and 32 are mounted on the left side screen unit and the right side screen unit respectively as the inclination detecting unit 3 shown in FIG. 1. Each angular velocity sensor detects inclination angle of the screen with the ground. Then, the watched screen detecting unit 4 shown in FIG. 1 compares values of inclination angles of both screens each other, and judges which screen out of the right side screen and the left side screen user watches as described in the following.

First, in the case that the two spread screens type electronic book such as ones shown in FIGS. 2A to 2D is used, it is considered to be general that user uses the electronic book in a situation in which the intersecting angle of two screens is not 180 degrees but a slight elevation angle similar to an angle when reading a conventional book. Since two screens are rarely watched simultaneously, it is natural for user to hold the electronic book so that the angle may be close to an angle shown in FIG. 2A when user watches the left side screen of the electronic book, and the angle may be close to an angle shown in FIG. 2B when user watches the right side screen of the electronic book during using the electronic book actually. Accordingly, the watched screen detecting unit 4 shown in FIG. 1 judges that a screen whose inclination angle with the ground is smaller than one of the other screen is the screen which user watches at present, on the presumption that user takes a natural posture such as a posture that user straightens his upper body up and holds the electronic book so that user faces the electronic book at the position lower than his face.

In the case that user reads a sentence which is displayed from the left side to the right side of the screen, the electronic book 1 displays the first page on the left side screen and the second page on the right side screen respectively similarly to a case to read a conventional book whose page is turned to the left. Then, user holds the electronic book 1 in a state shown in FIG. 2A, for example, and reads the first page, and afterward user inclines the electronic book 1 to a direction which makes the electronic book 1 enter into a state shown in FIG. 2B and then, user reads the second page. When user inclines the electronic book 1 to a direction which makes the electronic book 1 enter into a state shown in FIG. 2A again, a display on the screen is switched over, and consequently, the third page is displayed on the left side screen and the fourth page is displayed on the right side screen. The above-mentioned process is repeated hereinafter, that is, user reads a sentence displayed on the left side screen and afterward, on the right side screen through changing the inclination angle, and a display on the screen is switched over when user changes the inclination angle again so that the electronic book 1 may be in a state in which the right screen is visible. As a result, it is possible that user can read the following pages.

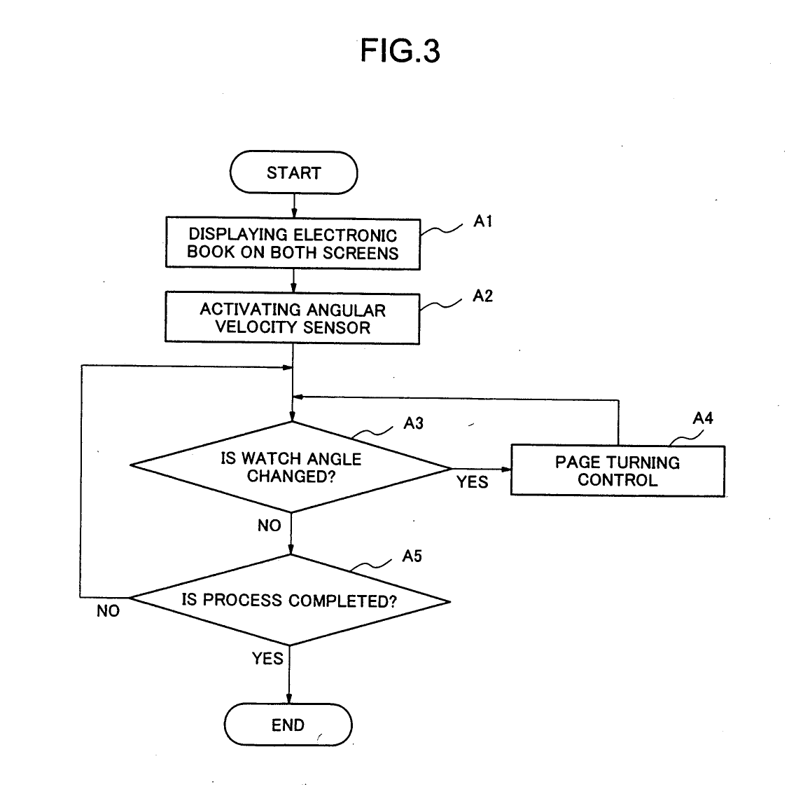

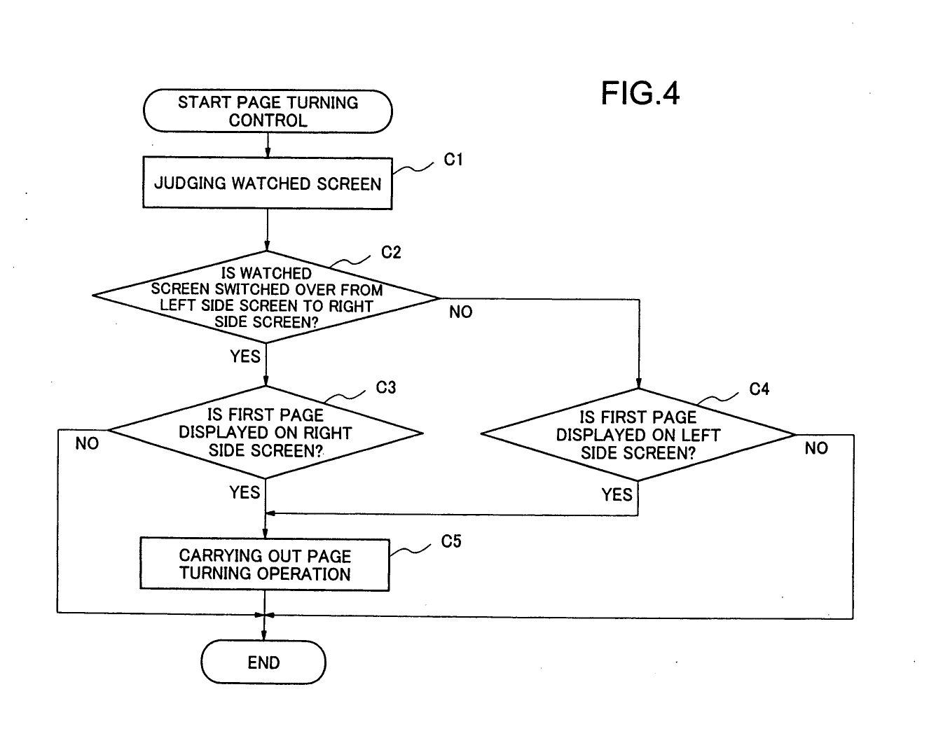

Next, a specific operation of the two spread screens type electronic book 1 mentioned above will be described with reference to flowcharts shown in FIG. 3 and FIG. 4. In the following description, the same code as one shown in FIG. 1 and FIGS. 2A to 2D is attached to the same component as one shown in FIG. 1 and FIGS. 2A to 2D.

First, pages to be read are displayed on the right side image displaying unit 2 and the left side image displaying unit 2, through opening the two spread screen type electronic book 1 which is folded, in an operation step A1 in FIG. 3.

Next, the angular velocity sensors mounted on the right side screen and the left side screen respectively are activated and measure inclination angles of the right side screen and the left side screen with the ground respectively, in an operation step A2. Moreover, the watched screen detecting unit 4 detects whether an angle for watching the electronic book 1 is changed, on the basis of the measured values of inclination angles of the right side screen and the left side screen, in an operation step A3. Here, it is assumed that the change of angle for watching the electronic book 1 means that a comparative value between the values of inclination angles of the right side screen and the left side screen is reversed in polarity. For example, in the case that a state of the electronic book 1 changes from a state shown in FIG. 2C to a state shown in FIG. 2D, the state of the electronic book 1 changes from a state that inclination angle of the right side screen is larger than one of the left side screen to a state that inclination angle of the left side screen is larger than one of the right side screen. The watched screen detecting unit 4 monitors the comparative value between the values of inclination angles of the right side screen and the left side screen. Moreover, the watched screen detecting unit 4 judges that one screen whose inclination angle is smaller than one of the other screen is a screen which user watches at present. A next operation is not carried out until change of the angle for watching the electronic book 1 is detected.

In the case that change of the angle for watching the electronic book 1 is detected in the operation step A3, the process advances to an operation step A4. The screen display controlling unit 5 carries out to turn a page in the operation step A4 according to a page turning executing process as shown in FIG. 4. FIG. 4 is a flowchart showing contents of a page turning controlling operation in the operation step A4. The watched screen detecting unit 4 monitors whether the screen which user watches is switched over from the left side screen to the right side screen or from the right side screen to the left side screen, in an operation step C1. In the case that it is judged that the screen which user watches is switched over from the left side screen to the right side screen in an operation step C2, the process advances to an operation step C3. If the first page of the electronic book which user reads at present is displayed on the right side screen, that is, if a page of the electronic book is turned to the right, the page turning process is carried out. Moreover, if a page of the electronic book which user reads is turned to the left, the page turning process is not carried out and the process returns to the operation step A3 in FIG. 3. On the other hand, in the case that it is judged that the screen which user watches is switched over from the right side screen to the left side screen in the operation step C2, the process advances to an operation step C4. If the first page of the electronic book which user reads is displayed on the left side screen, that is, if a page of the electronic book is turned to the left, the page turning process is carried out. Moreover, if a page of the electronic book, which user reads, is turned to the left, the page turning process is not carried out and the process returns to the operation step A3 in FIG. 3.

As shown in FIG. 3, the operation step A3 and the operation step A4 make a loop in the flowchart in order to read the following pages continuously through turning pages similarly.

In the case that user instructs end of process in a state that the angle for watching the electronic book 1 does not change in the operation step A3, the operation for reading the electronic book ends. The operation step A3 and the operation step A5 realize a loop so as to make the electronic book enter into a waiting state for change of the angle for watching the electronic book 1 in the case of no instruction to end the process.

By the above-mentioned operation steps, it is possible to read display on the screen with an advantageous feature of the two screens through carrying out the page turning process with a natural feeling, when reading display of two spread screens type electronic book.

Further, number of screens of the electronic book is not limited to two. If the electronic book includes more than two screens, and inclination angles of the screens can be set to different values respectively, and reading order of displays on the screens is determined, the present invention can be applied to the electronic book including more than two screens. Detection of the inclination angles of both screens is realized with other method such as a method by use of an acceleration sensor.

In the electronic book which includes plurality of screens, it is possible to specify always a screen which user watches at present, and to carry out the page turning process on the basis of the natural handling carried out at a time when the screen which user watches is switched over, according to the present exemplary embodiment. For this reason, it is possible that user reads display on the screen with no particular consciousness of the operation for turning a page.

Next, a third exemplary embodiment of the present invention will be described with reference to drawings.

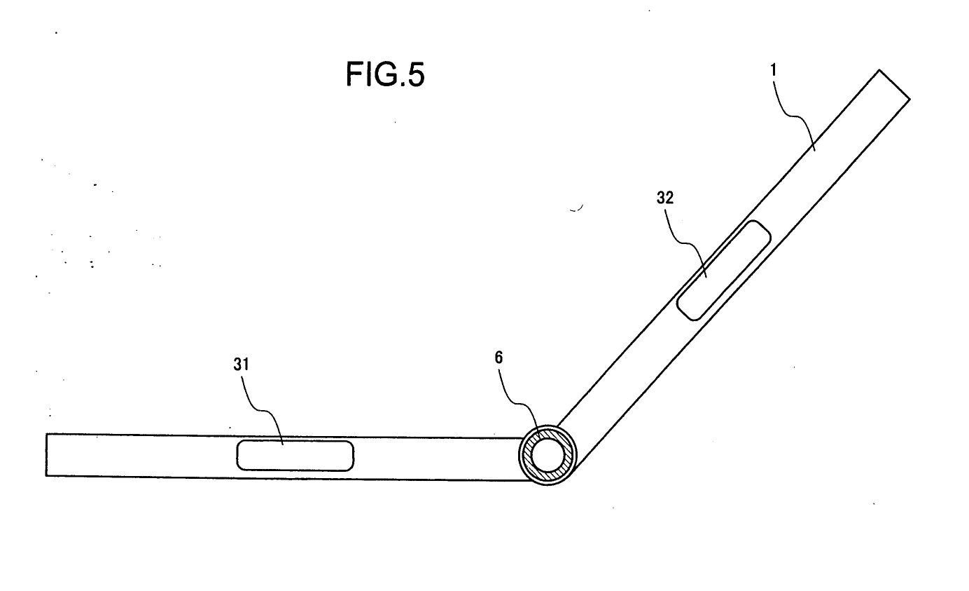

As shown in FIG. 5, an electronic book according to the exemplary embodiment includes a spread angle detecting unit 6 which detects spread angle of the screens in addition to the configuration which is shown in FIG. 1 and FIGS. 2A to 2D according to the above-mentioned second exemplary embodiment. The spread angle detecting unit 6 is realized, for example, by mounting a rotary type variable resistor on a screen connecting unit so that the resistance value of the variable resistor may be changed on the basis of the spread angle of the screens. With this structure, the spread angle detecting unit 6 can detect the spread angle of the screens through measuring resistance value of the variable resistor.

In the case that the electronic book is used in a state that a screen spreading unit of the electronic book is folded to some extent, since user can hardly see the screen which user does not watch, display of the not-watched screen is switched off to reduce power consumption according to the present exemplary embodiment.

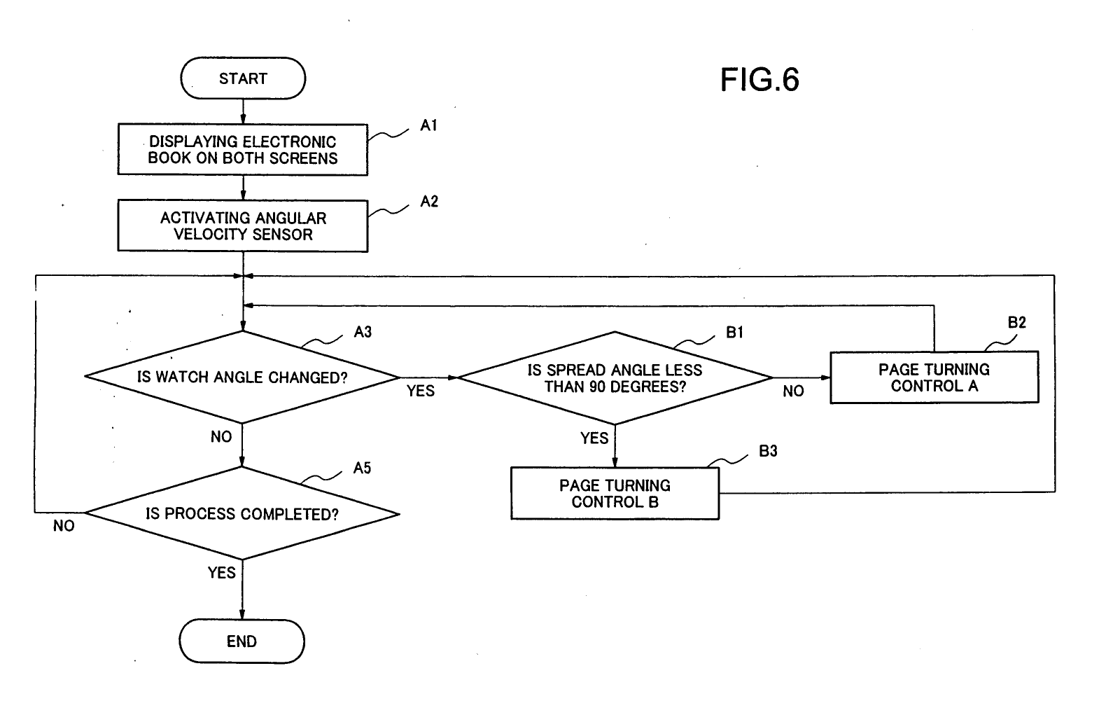

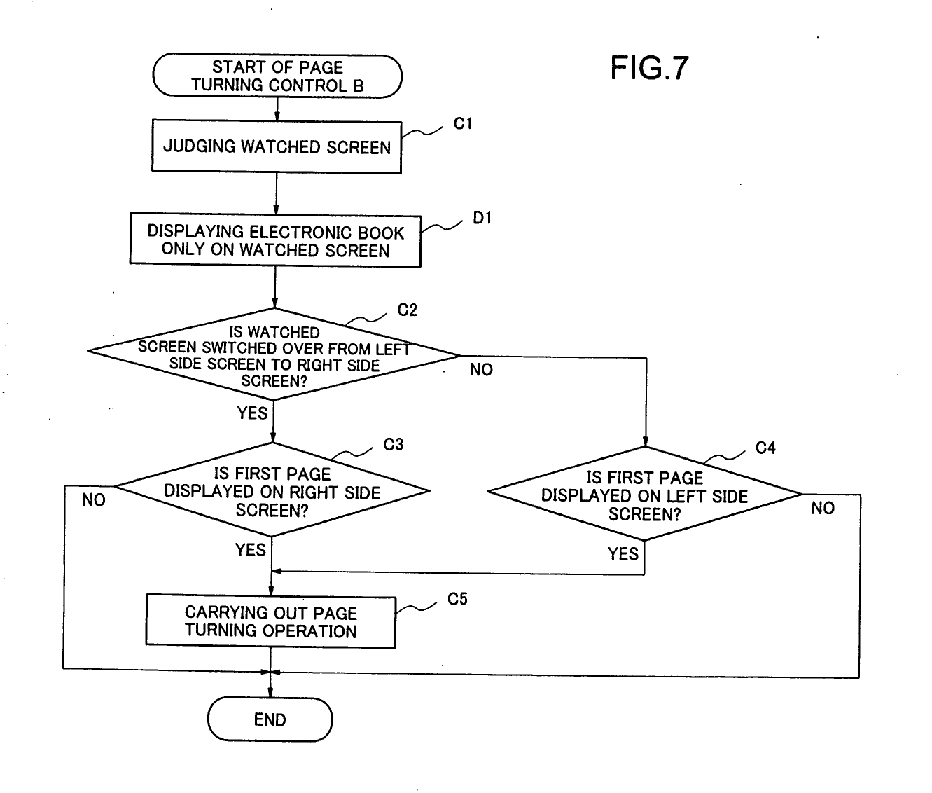

FIG. 6 and FIG. 7 are flowcharts showing operations according to the third exemplary embodiment. In the following description, the same code as one shown in FIGS. 3 and 4 is attached to the same component as one shown in FIGS. 3 and 4.

While operation steps A1 to A3 in FIG. 6 are identical to the operation steps A1 to A3 in FIG. 3 according to the second exemplary embodiment, the process advance to an operation B1 according to the third exemplary embodiment in the case that change of the angle for watching the electronic book is detected in the operation step A3. It is checked in the operation step B1 whether the spread angle of the screens of the electronic book 1 detected by the spread angle detecting unit 6 is less than 90 degrees. In the case that it is judged that the spread angle is not less than 90 degrees, “page turning control A” is carried out in an operation step B2. The “page turning control A” is identical to the page turning control flow shown in FIG. 4. On the other hand, in the case it is judged that the spread angle of the screens is less than 90 degrees, the process advances to an operation step B3 and “page turning control B” is carried out. FIG. 7 shows contents of an operation flow of the “page turning control B”. In an operation step C1 in FIG. 7, the watched screen detecting unit 4 judges whether the screen which user watches is the right side screen or the left side screen, and then, only the screen, which user watches, is controlled to display the contents of the electronic book in an operation step D1. In the case that it is judged that the screen, which user watches at present, is switched over from the left side screen to the right side screen in an operation step C2, the process advances to an operation step C3. If the first page of the electronic book, which user reads, is displayed on the right side screen, that is, if a page of the electronic book is turned to the right, the page turning process is carried out. Moreover, in the case that a page of the electronic book is turned to the left, the page turning process is not carried out and the process returns to the operation step A3 in FIG. 6. On the other hand, in the case that it is judged that the screen which user watches is switched over from the right side screen to the left side screen in the operation step C2, the process advances to an operation step C4. If the first page of the electronic book, which user reads, is displayed on the left side screen, that is, if a page of the electronic book is turned to the left, the page turning process is carried out. If a page of the electronic book is turned to the right, the page turning process is not carried out and the process returns to the operation step A3 in FIG. 6.

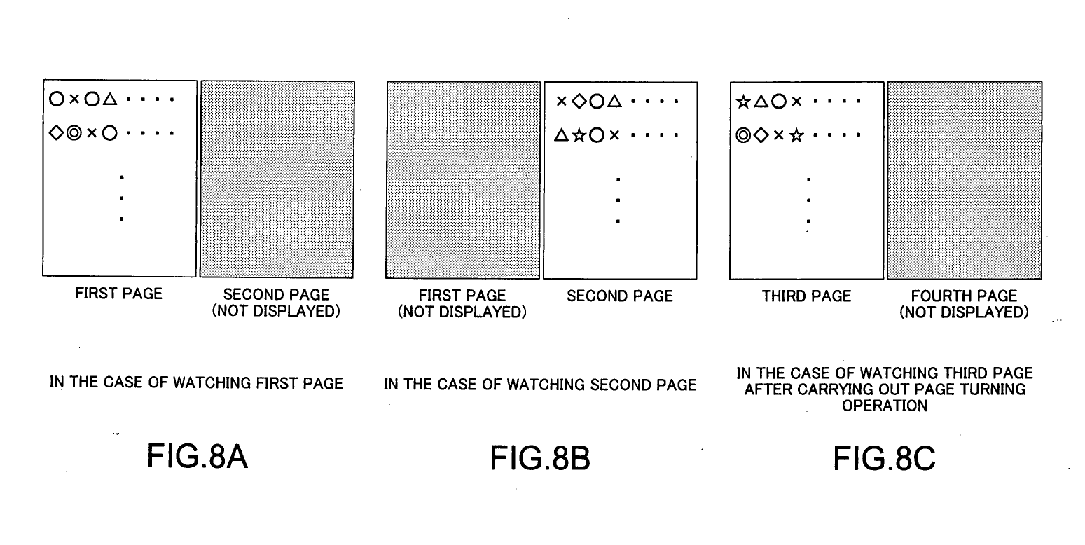

While the following process is the same as one of the second exemplary embodiment mentioned above, difference of the third exemplary embodiment from the second exemplary embodiment is that the screen displays only contents of the electronic book which user watches at present, and display on the not-watched screen is switched off. FIGS. 8A to 8C show examples of screen display control in response to a stage that user reads pages continuously. Since the control for displaying contents of the electronic book on the screen is carried out similarly to the page turning process at a time when the screen, which user watches, is switched over, and display on the not-watched screen is switched off, it is possible to realize that power consumption of the electronic book is made low without user having consciousness of the specific operation.

Further, while the spread angle of the screens is set to less than 90 degrees as the condition not to display contents of the electronic book, the spread angle is not necessarily limited to 90 degrees. Even if the spread angle is set to other angle according to the situation, it is possible to realize the effect of the exemplary embodiment of the present invention.

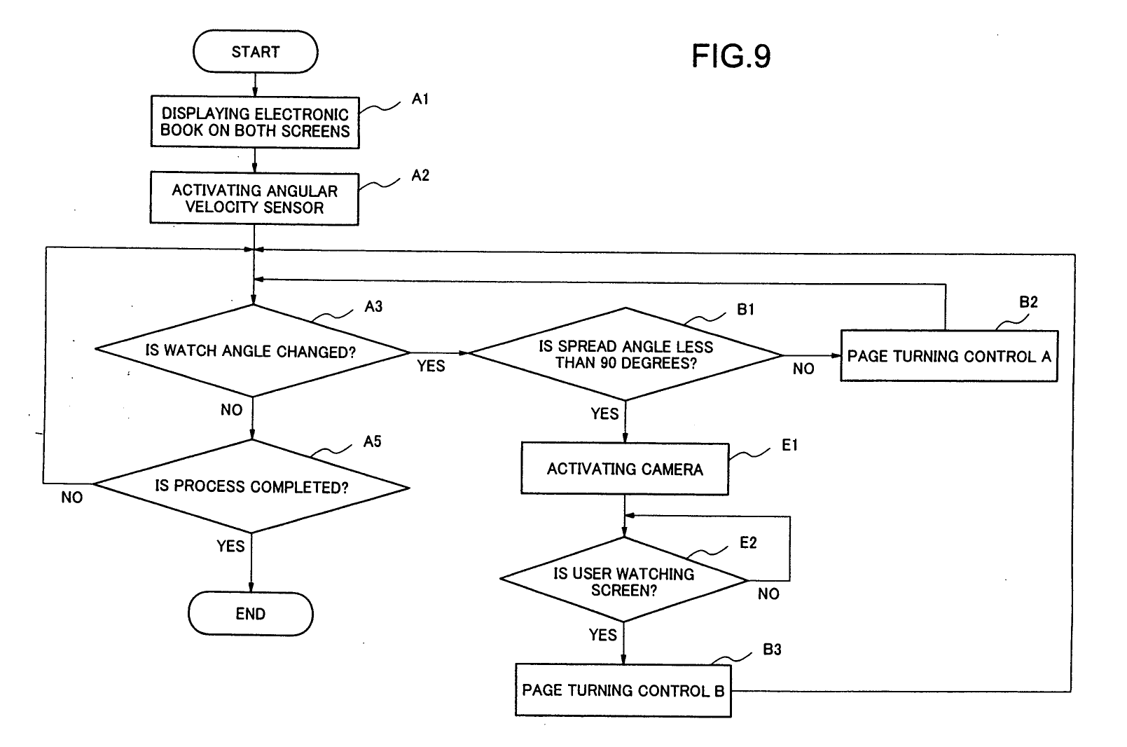

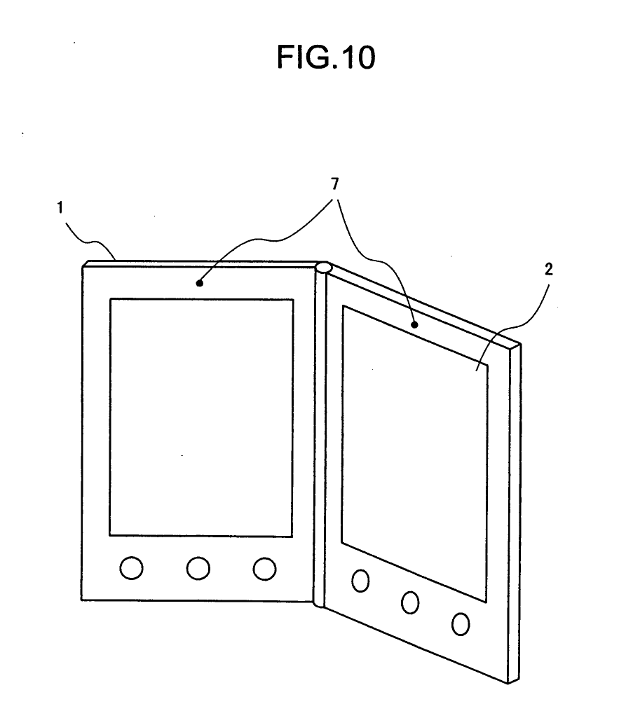

Next, a fourth exemplary embodiment will be described with reference to drawings. FIG. 9 is a flowchart showing an operation according to the fourth exemplary embodiment of the present invention. A target of operation is an electronic book, which is the two spread screens type electronic book as shown in FIGS. 2A to 2D, is equipped furthermore with cameras 7, which are for recognizing user's face, on the two screen sides respectively as shown in FIG. 10. In FIG. 9, the same code as one in FIG. 6 is attached to the same operation step as one in FIG. 6.

Operation steps A1 to A3 and B1 are the same as ones in FIG. 6 according to the third exemplary embodiment. According to the fourth exemplary embodiment of the present invention, in the case that it is judged that the spread angle of two screens is, for example, less than 90 degrees in the operation step B1, the process advances to an operation step E1 to activate the camera 7. Next, it is judged in an operation step E2 whether user's eye is directed to the screen, with a publicly known method such as a method to detect the direction of user's eye by an image analysis on direction of user's face, position of user's iris or the like through carrying out, for example, user's face recognition by use of a camera mounted on the watched screen side. In the case that user does not watch the screen, the process enters into a waiting state. On the other hand, in the case that it is recognized that user watches the screen, the process advances to an operation step B3. The operation to follow the operation step B3 is the same as one of the third exemplary embodiment mentioned above.

According to the present exemplary embodiment, since it is checked whether user watches the screen by the camera mounted on each screen side, it is possible to prevent a non-intentional page turning process from generating, for example, when user's posture inclines.

Further, it is possible to install the above mentioned operation controlling procedure of the portable electronic display apparatus within the apparatus as a program and to execute the procedure.

The above mentioned page turning method, which is used in the portable electronic display apparatus and which is disclosed in the patent document 1, causes a problem that the method can not be applied to the electronic book which includes a plurality of screens such as a folding type electronic book which includes two spread screens or the like. That is, in the case that user uses the two spread screens type electronic book actually, it is more natural to use the electronic book in a state that a spread angle of the folded portion of electronic book is slightly smaller than 180 degree than in a state that the spread angle is just 180 degrees. In the case that the dual views type liquid crystal display is applied to the display screen in such the state, there is no problem when, for example, the right side screen is watched from the right direction of the apparatus. However, when the right side screen is watched from the left direction of the apparatus, user can not watch the right side screen in some cases since the left side screen may become an obstacle dependently on the folding angle. Moreover, in the case that the electronic book is used in a state that one screen out of two screens is slightly inclined with the other screen, two screens always have inclination respectively. Therefore, it is impossible to judge which screen user watches at present, on the basis of each inclination of screen.

In contrast, as an example of the effect of the present invention, it is possible for user to carry out the page turning process with no particular consciousness of the operation for switching display on the screen and with a natural feeling.

While the invention has been particularly shown and described with reference to exemplary embodiments thereof, the invention is not limited to these embodiments. It will be understood by those of ordinary skill in the art that various changes inform and details may be made therein without departing from the spirit and scope of the present invention as defined by the claims.

The whole or part of the exemplary embodiments disclosed above can be described as, but not limited to, the following supplementary notes.

(Supplement 1) A portable electronic display apparatus, comprising:

at least two screen units whose intersecting angle is changeable;

an inclination detecting means, which are mounted on each of said screen units, for detecting inclination with the ground;

a watched screen detecting means for detecting a screen unit which user watches through comparing said inclination values of said screen units each other; and

a screen display controlling means for carrying out a page turning in the case that said watched screen detecting means detects that a screen unit which user watches is switched over and judges that a predetermined page turning executing condition is satisfied.

(Supplement 2) The portable electronic display apparatus according to supplement 1, wherein

said watched screen detection means judges that a screen unit which has the smallest inclination value among inclination values of said screen units with the ground, which are detected by said inclination detecting unit, is a screen unit which user watches.

(Supplement 3) The portable electronic display apparatus according to supplement 1 or supplement 2, wherein

said page turning executing condition is that a screen unit which user watches is switched over from a screen unit which displays the last page among pages displayed on said screen units to another screen unit.

(Supplement 4) The portable electronic display apparatus according to any one of supplement 1 to supplement 3, wherein only a screen unit which user watches is controlled to be in a displaying state.

(Supplement 5) The portable electronic display apparatus according to any one of supplement 1 to supplement 4, further comprising a screen spreading angle detecting means which detects an intersecting angle of said screen units.

(Supplement 6) The portable electronic display apparatus according to supplement 5, wherein

in the case that an intersecting angle of said screen units is less than a predetermined angle, only a screen unit which said watched screen detecting means judges to be a screen unit which user watches is controlled to be in a displaying state.

(Supplement 7) The portable electronic display apparatus according to any one of supplement 1 to supplement 6, wherein

each of said screen units further includes a watch judging means which carries out recognizing user's face and judges whether user watches said screen unit.

(Supplement 8) The portable electronic display apparatus according to supplement 7, wherein

in the case that a screen unit which said watched screen detecting means judges to be a screen which user watches is judged by said watch judging means not to be a screen unit which user watches, carrying out a page turning is reserved.

(Supplement 9) A control method of a portable electronic display apparatus including at least two screen units whose intersecting angle is changeable and each of which includes an inclination detecting means, the method comprising the steps of

detecting a screen unit which user watches through comparing said inclination values of said screen units each other; and

turning page in the case that it is detected that a screen unit which user watches is switched over and it is judged that a predetermined page turning executing condition is satisfied.

(Supplement 10) The control method of the portable electronic display apparatus, according to supplement 9, wherein

it is judged that a screen unit which has the smallest inclination value among inclination values of said screen units with the ground is a screen unit which user watches.

(Supplement 11) The control method of the portable electronic display apparatus, according to supplement 9 or supplement 10, wherein

said page turning executing condition is that a screen unit which user watches is switched over from a screen unit which displays the last page among pages displayed on said screen units to another screen unit.

(Supplement 12) The control method of the portable electronic display apparatus, according to any one of supplement 9 to supplement 11, wherein only a screen unit which user watches is controlled to be in a displaying state.

(Supplement 13) The control method of the portable electronic display apparatus, according to any one of supplement 9 to supplement 12, further comprising the step of detecting an intersecting angle of said screen units.

(Supplement 14) The control method of the portable electronic display apparatus, according to supplement 13, wherein

in the case that an intersecting angle of said screen units is less than a predetermined angle, only a screen unit which is judged to be a screen unit which user watches is controlled to be in a displaying state.

(Supplement 15) The control method of the portable electronic display apparatus, according to any one of supplement 9 to supplement 14, further comprising the step of judging whether user watches screen unit by recognizing user's face.

(Supplement 16) The control method of the portable electronic display apparatus, according to supplement 15, wherein

in the case that a screen unit which is judged to be a screen which user watches in said step of detecting a screen unit which user watches is judged not to be a screen which user watches in said step of judging whether user watches screen unit, carrying out a page turning is reserved

(Supplement 17) A control program of a portable electronic display apparatus including at least two screen units whose intersecting angle is changeable and each of which includes an inclination detecting means, comprising the steps of:

detecting a screen unit which user watches through comparing said inclination values of said screen units each other; and

turning page in the case that it is detected that a screen unit which user watches is switched over and it is judged that a predetermined page turning executing condition is satisfied.

(Supplement 18) The control program of the portable electronic apparatus, according to supplement 17, wherein

it is judged that a screen unit which has the smallest inclination value among inclination values of said screen units with the ground is a screen unit which user watches.

(Supplement 19) The control program of the portable electronic apparatus, according to supplement 17 or supplement 18, wherein

said page turning executing condition is that a screen unit which user watches is switched over from a screen unit which displays the last page among pages displayed on said screen units to another screen unit.

(Supplement 20) The control program of the portable electronic apparatus, according to any one of supplement 17 to supplement 19, wherein only a screen unit which user watches is controlled to be in a displaying state.

(Supplement 21) The control program of the portable electronic apparatus, according to any one of supplement 17 to supplement 20, further comprising the step of detecting an intersecting angle of said screen units.

(Supplement 22) The control program of the portable electronic apparatus, according to supplement 21, wherein

in the case that an intersecting angle of said screen units is less than a predetermined angle, only a screen unit which is judged to be a screen unit which user watches is controlled to be in a displaying state.

(Supplement 23) The control program of the portable electronic apparatus, according to any one of supplement 17 to supplement 22, further comprising the steps of judging whether user watches screen unit by recognizing user's face.

(Supplement 24) The control program of the portable electronic apparatus, according to supplement 23, wherein

in the case that a screen unit which is judged to be a screen which user watches in said step of detecting a screen unit which user watches is judged not to be a screen which user watches in said step of judging whether user watches screen unit, carrying out a page turning is reserved

1. A portable electronic display apparatus, comprising:
at least two screen units whose intersecting angle is changeable;
an inclination detecting means, which are mounted on each of said screen units, for detecting inclination with the ground;
a watched screen detecting means for detecting a screen unit which user watches through comparing said inclination values of said screen units each other; and
a screen display controlling means for carrying out a page turning in the case that said watched screen detecting means detects that a screen unit which user watches is switched over and judges that a predetermined page turning executing condition is satisfied.

2. The portable electronic display apparatus according to claim 1, wherein
said watched screen detection device judges that a screen unit which has the smallest inclination value among inclination values of said screen units with the ground, which are detected by said inclination detecting unit, is a screen unit which user watches.

3. The portable electronic display apparatus according to claim 1, wherein
said page turning executing condition is that a screen unit which user watches is switched over from a screen unit which displays the last page among pages displayed on said screen units to another screen unit.

4. The portable electronic display apparatus according to claim 1, wherein only a screen unit which user watches, is controlled to be in a displaying state.

5. The portable electronic display apparatus according to claim 1, further comprising a screen spreading angle detecting device which detects an intersecting angle of said screen units.

6. The portable electronic display apparatus according to claim 5, wherein
in the case that an intersecting angle of said screen units is less than a predetermined angle, only a screen unit which said watched screen detecting device judges to be a screen unit which user watches is controlled to be in a displaying state.

7. The portable electronic display apparatus according to claim 1, wherein
each of said screen units further includes a watch judging device which carries out recognizing user's face and judges whether user watches said screen unit.

8. The portable electronic display apparatus according to claim 7, wherein
in the case that a screen unit which said watched screen detecting device judges to be a screen which user watches is judged by said watch judging device not to be a screen unit which user watches, carrying out a page turning process is reserved.

9. A control method of a portable electronic display apparatus including at least two screen units whose intersecting angle is changeable and each of which includes an inclination detecting device, the method comprising the steps of
detecting a screen unit which user watches through comparing said inclination values of said screen units each other; and
turning page in the case that it is detected that a screen unit which user watches is switched over and it is judged that a predetermined page turning executing condition is satisfied.

10. The control method of the portable electronic display apparatus, according to claim 9, wherein
it is judged that a screen unit which has the smallest inclination value among inclination values of said screen units with the ground is a screen unit which user watches.

11. The control method of the portable electronic display apparatus, according to claim 9, wherein
said page turning executing condition is that a screen unit which user watches is switched over from a screen unit which displays the last page among pages displayed on said screen units to another screen unit.

12. The control method of the portable electronic display apparatus, according to claim 9, wherein only a screen unit which user watches is controlled to be in a displaying state.

13. The control method of the portable electronic display apparatus, according to claim 9, further comprising the step of detecting an intersecting angle of said screen units.

14. The control method of the portable electronic display apparatus, according to claim 13, wherein
in the case that an intersecting angle of said screen units is less than a predetermined angle, only a screen unit which is judged to be a screen unit which user watches is controlled to be in a displaying state.

15. The control method of the portable electronic display apparatus, according to claim 9, further comprising the step of judging whether user watches screen unit by recognizing user's face.

16. The control method of the portable electronic display apparatus, according to claim 15, wherein
in the case that a screen unit which is judged to be a screen which user watches in said step of detecting a screen unit which user watches is judged not to be a screen which user watches in said step of judging whether user watches screen unit, carrying out a page turning is reserved.

17. A computer readable medium which stores a control program of a portable electronic display apparatus including at least two screen units whose intersecting angle is changeable and each of which includes an inclination detecting device, said control program making a computer execute the steps of:
detecting a screen unit which user watches through comparing said inclination values of said screen units each other; and
turning page in the case that it is detected that a screen unit which user watches is switched over and it is judged that a predetermined page turning executing condition is satisfied.

18. The computer readable medium which is stored the control program of the portable electronic apparatus, according to claim 17, wherein
it is judged that a screen unit which has the smallest inclination value among inclination values of said screen units with the ground is a screen unit which user watches.

19. The computer readable medium which is stored the control program of the portable electronic apparatus, according to claim 17, wherein
said page turning executing condition is that a screen unit which user watches, is switched over from a screen unit which displays the last page among pages displayed on said screen units, to another screen unit.

20. The computer readable medium which is stored the control program of the portable electronic apparatus, according to any of claim 17, wherein only a screen unit which user watches is controlled to be in a displaying state.
